(19) United States
(12) Patent Application Publication
(10) Pub. No.: US 2025/0089619 A1
(43) Pub. Date: Mar. 20, 2025

(54) LIGHTING SYSTEM FOR OUTDOOR POWER MACHINE

(71) Applicant: Greenworks (Jiangsu) Co., Ltd., Changzhou (CN)

(72) Inventors: Qunli WEI, Changzhou (CN); Qinghua SHI, Changzhou (CN); Dongdong SHI, Changzhou (CN); Christopher EICHEL, Charlotte, NC (US); Nicholas SUCHOZA, Charlotte, NC (US); Jiafu XUE, Changzhou (CN)

(21) Appl. No.: 18/564,815

(22) PCT Filed: Sep. 13, 2022
(86) PCT No.: PCT/CN2022/118335

§ 371 Date: Nov. 28, 2023

(51) Int. Cl. A01D 69/02; A01D 34/66; A01D 101/00; B60Q 1/24; B60Q 1/50

(52) U.S. Cl. CPC A01D 69/02; A01D 34/66; B60Q 1/24; B60Q 1/543; A01D 2101/00

(57) ABSTRACT

An outdoor power machine includes a chassis having main frame rails. Two or more drive wheel assemblies are physically mounted to the chassis. Each drive will assembly is coupled to an electric motor. An electrical power pack is configured to supply electric energy to the electric motors. One or more steer wheels are mounted to the chassis. A lighting package is mounted on the machine such that the lighting package is visible from at least one of: the forward and rear aspects of the machine, and at least one of: the left and right aspects of the machine.

### BACKGROUND OF THE INVENTION

This invention relates generally to outdoor power equipment, and more particularly to self-propelled outdoor power machines that have lighting systems and more specifically to self-propelled outdoor power machines that have lighting systems visible from points distributed three hundred sixty degrees (360°) around the machine.

### BACKGROUND

Various types of outdoor power machines are known. Examples of common machines include lawn mowers and lawn tractors. Some outdoor power machines have an operator seat and are considered “ride-on”, “riders”, or “riding” machines. Others accommodate an operator in a standing position, described as a “stand-on” or “stander” machine.

Some known outdoor power machines are battery powered. They include a battery pack which provides electrical power for the primary operating components of the machine, such as the drive wheels and mower deck or other powered implements. The battery pack also provides electrical power for controls, displays, and accessories of the machine.

One problem with prior art outdoor power machines is that they might not be visible in lowlight situations from various angles. This might be particularly a problem in situations like golf courses or driving ranges where operator safety depends upon visibility of the machine.

### BRIEF SUMMARY OF THE INVENTION

This problem is addressed by an outdoor power machine having a lighting system integrated into the body and/or frame such that the outdoor power machine is visible from any location offset from the outdoor power machine in generally the same plane.

According to one aspect of the technology described herein, an outdoor power machine includes a chassis having main frame rails. Two or more drive wheel assemblies are physically mounted to the chassis. Each drive will assembly is coupled to an electric motor. An electrical power pack is configured to supply electric energy to the electric motors. One or more steer wheels are also attached to the chassis. A lighting package is mounted on the machine such that the lighting package is visible from at least one of: the forward and rear aspects of the machine, and at least one of: the left and right aspects of the machine.

### BRIEF DESCRIPTION OF THE DRAWINGS

The invention may be best understood by reference to the following description taken in conjunction with the accompanying drawing figures in which:

FIG. 1 is a front perspective view of an exemplary ride-on zero-turn outdoor power machine;

FIG. 2 is a rear perspective view of the machine of FIG. 1;

FIG. 3 is a side elevation view of the machine of FIG. 1;

FIG. 11 is a portion of the side elevation view taken at region 3A in FIG. 3 showing a detail of the lighting system;

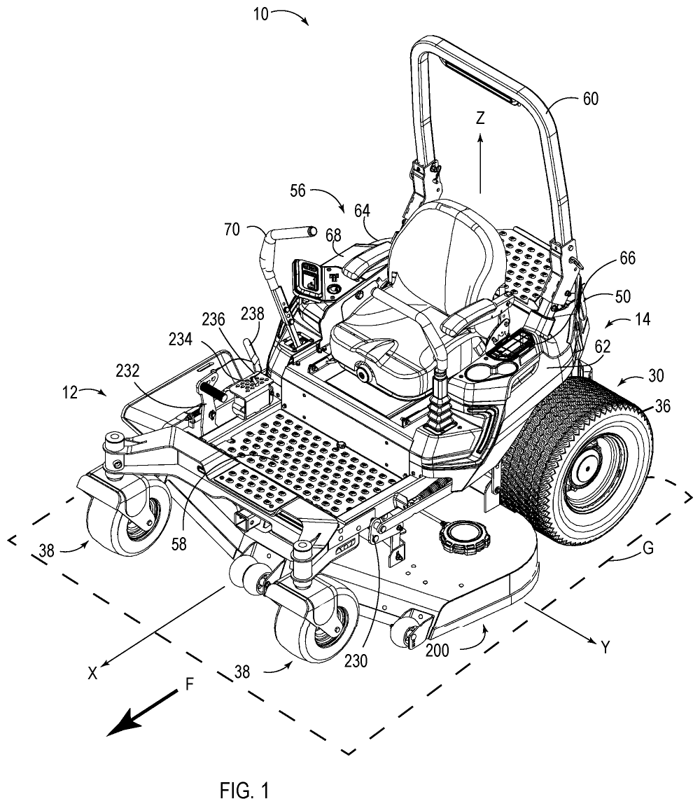

FIG. 4 is a perspective view of a chassis of the machine of FIG. 1;

FIG. 5 is a front perspective view of an exemplary stand-on zero-turn outdoor power machine;

FIG. 6 is a rear perspective view of the machine of FIG. 5;

FIG. 7 is a side elevation view of the machine of FIG. 5;

FIG. 8 is a perspective view of a chassis of the machine of FIG. 5;

FIG. 9 is a perspective view of an exemplary mowing deck;

FIG. 10 is a bottom plan view of the mowing deck of FIG. 9;

FIG. 12 is a front plan view of the machine of FIG. 1;

FIG. 13 is a rear plan view of the machine of FIG. 1;

FIG. 14 is a front plan view of the machine of FIG. 5; and

FIG. 15 is a rear plan view of the machine of FIG. 5.

### DETAILED DESCRIPTION OF THE INVENTION

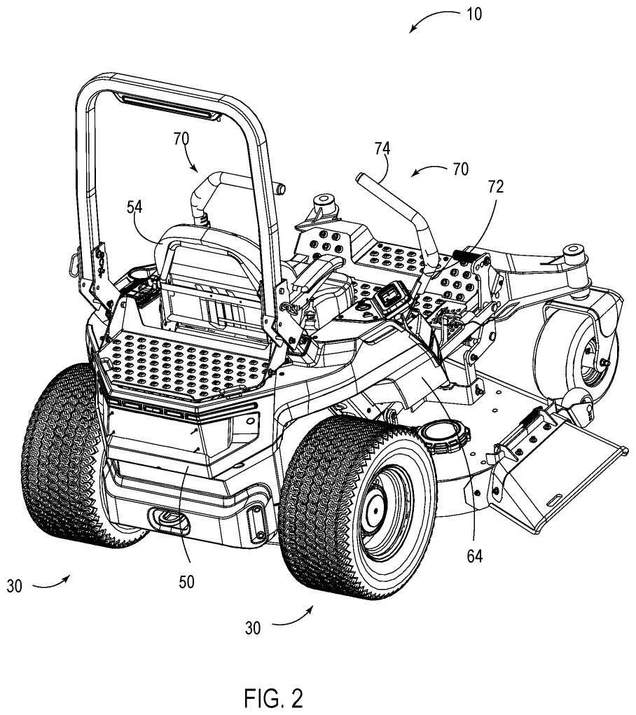

Referring to the drawings wherein identical reference numerals denote the same elements throughout the various views, FIGS. 1-3 show a representative embodiment of an outdoor power machine 10. The machine 10 extends along an axial direction (arrow “X”) between a front end 12 and a rear end 14. The points of contact of the wheels of the machine 10 collectively define a ground plane “G”. The machine 10 is configured to present lighted surfaces to a viewer positioned at or near the ground plane G in any direction (front, left, back, or right) around the machine 10. In this regard, the machine 10 includes lighted panels strategically placed to maximize visibility in at least one direction and in some cases multiple directions. In this manner, the lighted panels positioned on the machine 10 provide information to remote viewers that can include, but is not limited to, the following: the location of the machine 10, the direction of movement of the machine 10, and operational status of the machine 10, such as whether the machine 10 is properly charged.

It is noted that, as used herein, the terms “axial” and “longitudinal” both refer to a direction parallel to the axis X, while “vertical” refers to a direction perpendicular to the axial direction and to the ground plane G (see arrow “Z” in FIG. 1) and “lateral” refers to a direction mutually perpendicular to the axial and vertical directions (see arrow “Y” in FIG. 1). A primary forward direction of ground travel is shown by the arrow “F” in FIG. 1. These directional terms are used merely for convenience in description and do not require a particular orientation of the structures described thereby.

In the illustrated example, the outdoor power machine 10 is a zero-turn-radius type machine, alternatively referred to as a “zero-turn” machine. This type of machine is capable of changing its direction of travel (heading) without significant forward or backward movement. This is accomplished by differential rotation of drive wheels on opposite sides of the machine 10 to produce a yawing motion. For example, rotating the right-side wheel forward and simultaneously rotating the left-side wheel backward at the same wheel speed (RPM) will cause the machine 10 to yaw (turn) to the left without moving forwards or backwards. Related steering effects may be obtained by rotating drive wheels on opposite sides in different directions and different wheel speeds, by holding one wheel stationary while driving the opposite-side wheel in a chosen direction, or by rotating the wheels on opposite sides in the same direction at different wheel speeds.

The principles described herein are also applicable to a non-zero-turn mower (not shown) using a conventional steering linkage to pivot (steer) some or all of the wheels.

In the example shown in FIGS. 1-3, the machine 10 is a ride-on machine (alternatively referred to as a “rider” or “riding machine”).

The machine 10 has a chassis 16 (FIG. 4) which provides structural support as well as mounting locations for the various components of the machine 10. Any material with adequate structural strength may be used to construct the chassis 16. Examples of suitable materials include metals such as aluminum and steel and their alloys. The chassis 16 may be monolithic or may be built up from smaller components, e.g., via fasteners, adhesives, or welding.

The chassis 16 includes a pair of spaced-apart main frame rails 18 extending in a longitudinal direction from the front end 12 of the machine 10 to the rear end 14 of the machine 10. Cross-members 20 interconnect the main frame rails 18. Top surfaces 22 of the cross-members 20 are positioned even with or lower than the bottom surfaces 24 of the main frame rails 18.

A front axle assembly 26 interconnects the main frame rails 18 at the front end 12 of the machine 10.

The machine 10 is equipped with an electric power pack 28 suitable for storing and discharging electrical energy. In the illustrated example, the electric power pack 28 is a storage battery including one or more chemical cells, for example lithium ion cells. Other liquid battery chemistries may be substituted, as well as solid state batteries, capacitors, or similar devices which may exist currently or be later developed. The electric power pack 28 may include ancillary electrical components such as inverters, transformers, voltage converters, relays, circuit breakers, and/or sensors. In the illustrated example, the electric power pack 28 includes at least one set of terminals providing a high voltage output (e.g. 82 V) for operating the primary components of the machine 10, such as the drive wheels and mower deck or other powered implement. It also includes another set of terminals providing a low voltage output (e.g. 12 V) for operating the control systems of the machine 10 as well as certain accessories.

The electric power pack 28 is positioned on the cross-members 20 and may be secured by fasteners, clips, latches, or the like (not shown).

The electric power pack 28 is positioned such that some portion of it is located at or below the bottom surfaces 24 of the main frame rails 18. Stated another way, the electric power pack 28 is positioned “between” the main frame rails 18, rather than sitting above or on top of the main frame rails 18.

The machine 10 is equipped with a drive wheel assembly 30, one on each side. Each drive wheel assembly 30 includes an integral drive hub 32 containing an internal electric motor, gear reduction drive, an optional brake (not separately illustrated), a drive wheel 34, and a tire 36 mounted to the drive wheel 34. The integral drive hub 32 is physically mounted to the chassis 16 such that the drive wheel 34 can rotate relative to the chassis 16. As will be described in further detail, the machine 10 is configured such that the wheel speed and direction of rotation can be controlled independently for the left-and right-side drive wheel assemblies 30. In the illustrated example, the drive wheel assemblies 30 are located at or near the rear end 14 of the machine 10. Alternatively, the drive wheel assemblies 30 could be located at or near the front end 12 of the machine 10.

The machine 10 is equipped with left-and right-side steer wheel assemblies 38. Each steer wheel assembly 38 includes a pivot assembly 40, a steer wheel 42, and a tire 44 mounted to the steer wheel 42. Each steer wheel assembly 38 is mounted to the chassis 16 such that the steer wheel 42 can rotate relative to the chassis 16 as well as pivot freely about an upright (vertical or near-vertical) axis. The steer wheel assemblies 38 function as casters and therefore passively steer the machine 10. As noted above, the principles described herein are also applicable to a non zero-turn mower (not shown) using a conventional steering linkage to pivot (i.e., actively steer) some or all of the wheels.

The machine 10 is equipped with suitable electrical connections, controls, and switching equipment to permit the operator to control the drive functions of the machine 10. In the illustrated example, the machine 10 includes a left drive motor controller 46 and a right drive motor controller 48. Each of these drive motor controllers 46, 48 includes an electrical power connection to the electric power pack 28 as well as connections to operator controls as described below. Each drive motor controller 46, 48 is operable to receive a command signal from an operator control and to provide electrical power to drive its associated drive wheel assembly 30 at the commanded wheel speed and direction.

The machine 10 includes a body 50 or superstructure positioned above the chassis 16. The body 50 functions to enclose the operating components of the machine 10, to provide the mounting structure for controls and accessories of the machine 10, and to provide a desired external appearance.

The body 50 includes a battery cover assembly 52 which encloses the electric power pack 28.

An operator seat 54 is mounted on top of the battery cover assembly 52. The operator seat 54 may be adjustable in one or more directions, may include retractable armrests, and may include a seatbelt or other restraint for the operator. The battery cover assembly 52 and the operator seat 54 collectively define an “operator station” 56 which functions to support the operator in a position with access to machine controls during operation.

A foot deck 58 is mounted to the chassis 16 forward of the battery cover assembly 52. This serves as a support for the operator's feet. As illustrated, it may be provided with a raised tread structure to increase traction and avoid slippage.

A rollover protection system (“ROPS”) 60 is mounted to the body 50 just aft of the operator seat 54. This is a hoop-like structure or rollbar which extends above the operator's head in the seated position. This functions to prevent injury to the operator should the machine 10 rollover in operation. In the illustrated example, the rollover protection system 60 can be folded down or removed to permit operations under low-hanging structures or vegetation, or to make the machine 10 more compact for transportation.

The body 50 includes left and right fenders 62, 64 respectively which flank the left and right sides of the operator seat 54. The left fender 62 is topped by a left console 66 and the right fender 64 is topped by a right console 68.

The body 50 carries one or more operator controls within reach of the operator seat 54. The primary operator controls include a pair of steering levers 70, one for the left side and one for the right side. Each steering lever 70 is generally L-shaped and includes a vertical section 72 pivotally mounted to the body 50 near the forward edge of the operator seat 54, and a horizontal section 74 which extends from the top of the vertical section 72 towards the centerline X of the machine 10.

Each steering lever 70 is pivotally mounted such that it can move in a fore-aft direction to control drive wheel speed. More specifically, the steering lever 70 is spring-loaded to a neutral position which commands drive wheel speed to stop and/or apply a brake. Movement in the forward direction away from the neutral position commands forward wheel rotation, with RPM proportional to steering lever deflection. Movement in the rearward direction away from the neutral position commands reverse wheel rotation, with RPM proportional to steering lever deflection.

Each steering lever 70 is further pivotally mounted so that it can move in a lateral direction between an outboard parking position and a inboard use position.

Optionally, the machine 10 may be equipped with parking switches (not illustrated) which are operable to detect if the steering levers 70 are in the outboard position or the inboard position. The parking switches may be configured such that the machine drive wheel assemblies 30 cannot be operated unless both steering levers 70 are pivoted to the inboard position.

Further controls are not separately illustrated but can include one or more of the following: a key switch or other security device; a main power switch; an emergency stop control; a blade start/stop switch; a blade speed control; a drive speed limiter or cruise control; and lighting controls. These further controls may be mounted, for example to the left or right consoles 68, 70.

The outdoor power machine 10 may be used as follows. First, the operator sits in the operator seat 54 and activates the key switch or main power switch. A blade start/stop switch or other switch is used to turn on mowing blades or other powered implement, and the implement is adjusted to an operating position, such as a desired cutting height for mowing. The steering levers 70 are moved from the outboard parking position to the inboard use position. The operator then uses the steering levers 70 to drive the outdoor power machine 10 in the desired direction while mowing or other implement operation takes place. It will be understood from the above description that manipulation of the steering levers 70 is sufficient to control forward and aft movement of the outdoor power machine 10, as well as braking and steering.

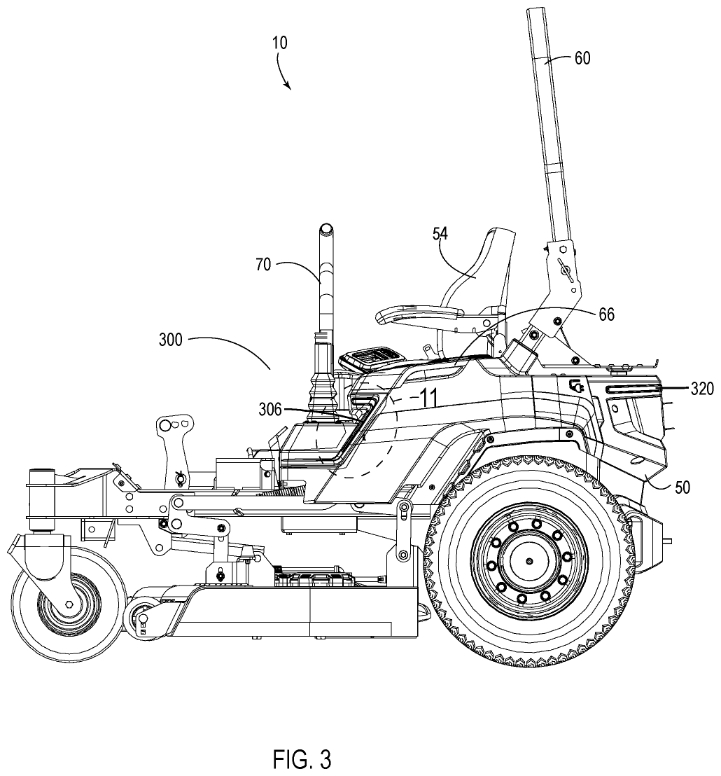

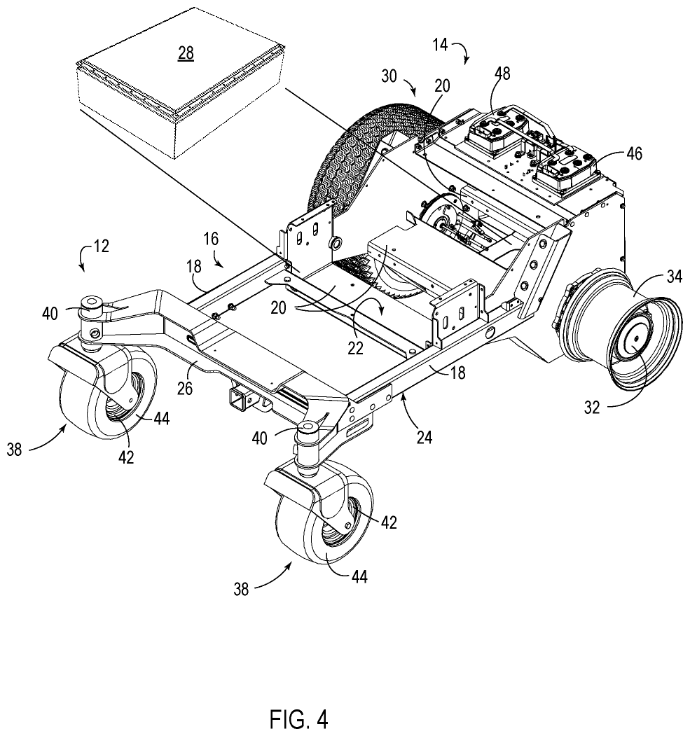

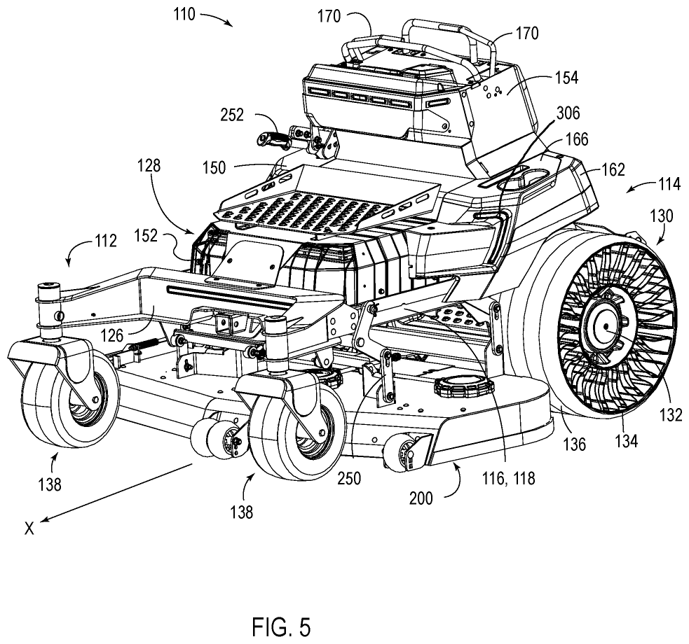

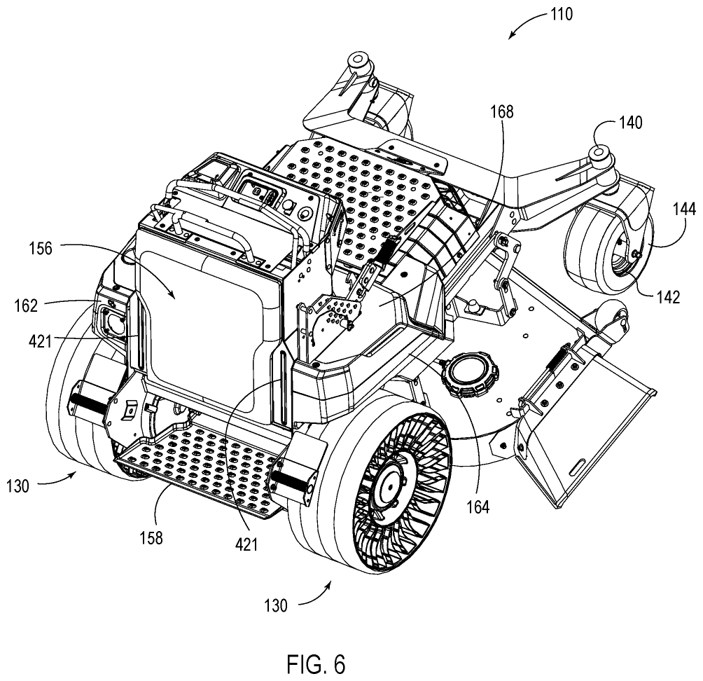

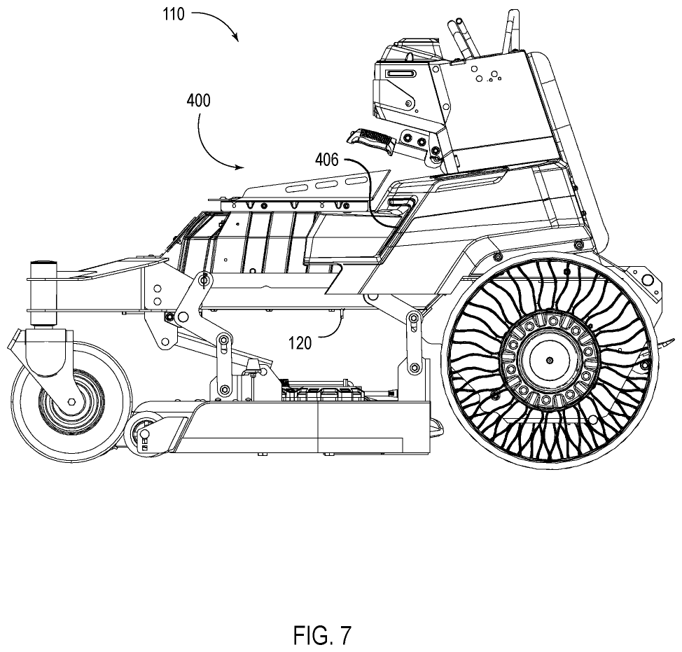

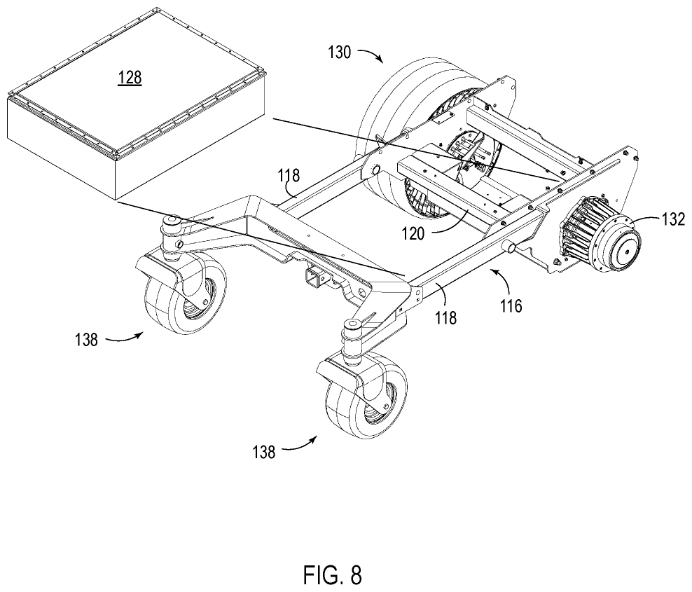

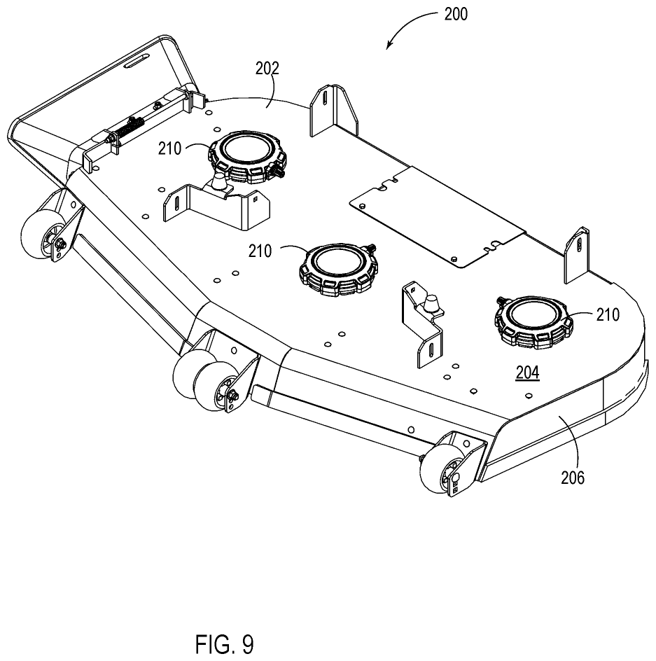

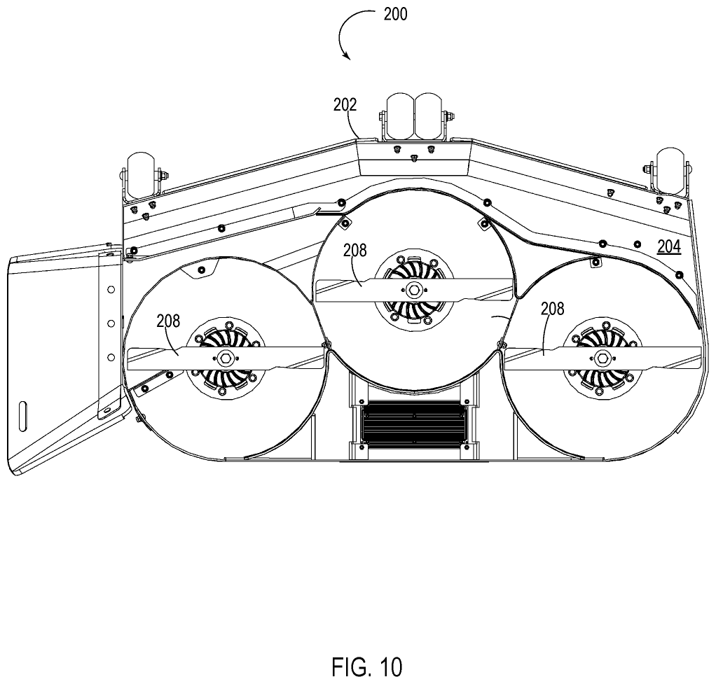

Referring now to FIGS. 3, 12 and 13; the machine 10 includes a lighting package 300 that is configured to provide 360° illumination generally parallel to the ground plane G as indicated above. The lighting package 300 includes a pair of forward-quarter lighting panel 306, one positioned on the left side of the machine 10 as shown in FIG. 3 and another positioned on the right side of the machine 10 as shown in FIG. 12. According to the illustrated embodiment, the left side forward quarter lighting panel 306 is symmetrically positioned about the axis X to the right side forward quarter lighting panel 306. Similarly, a pair of rear-quarter lighting panels 320 are positioned on the left and right sides of the machine 10 at the rear.

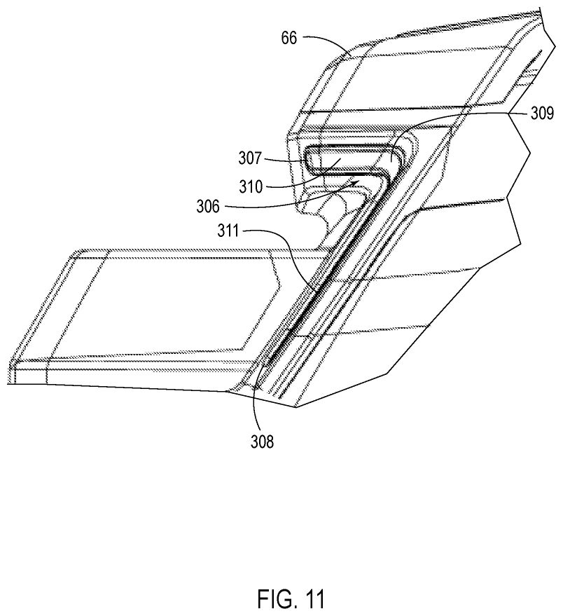

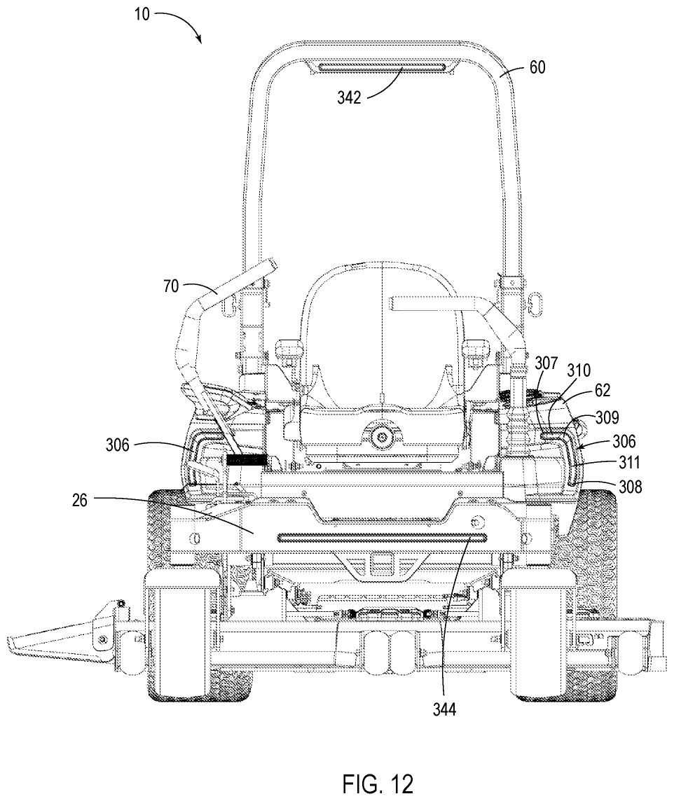

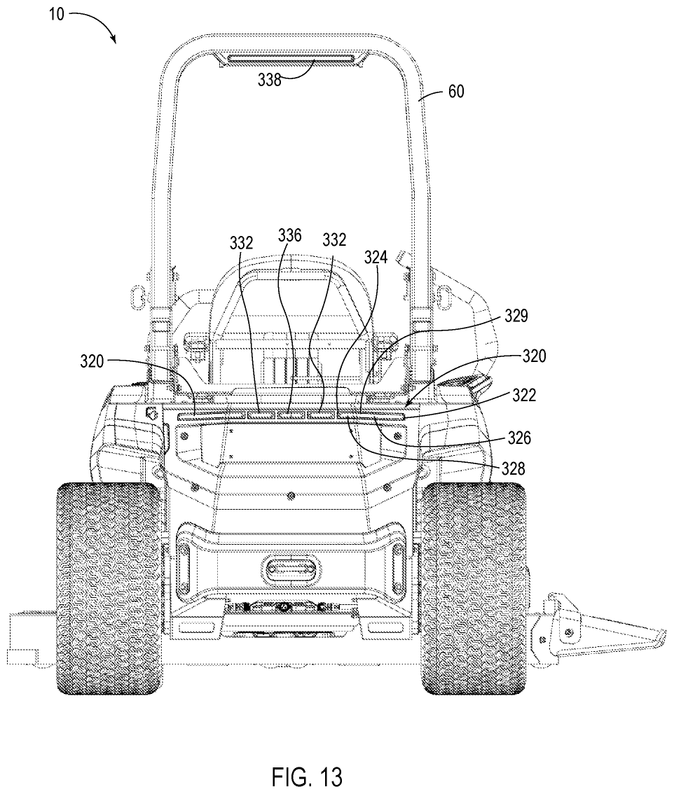

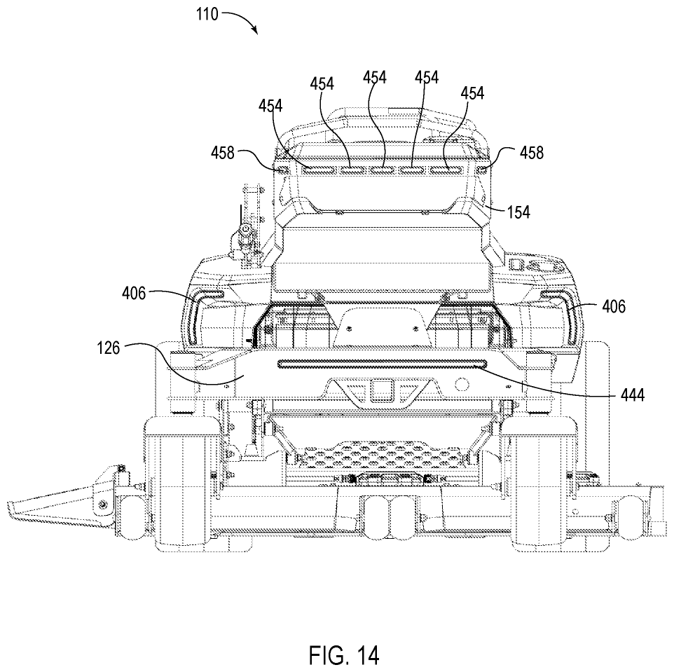

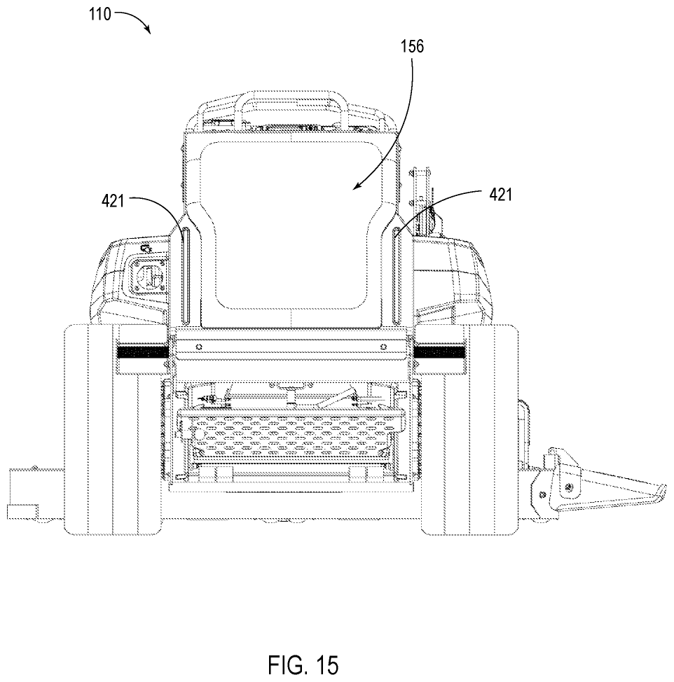

Referring now to FIG. 11, the forward-quarter lighting panel 306 extends from a first end 307 to a second end 308. The forward-quarter lighting panel 306 defines a surface 310 at a portion near the first end 307 and a surface 311 at a portion near the second end 308. The surface 310 and the surface 311 intersect at a region 309. In the illustrated embodiment, the forward-quarter lighting panel bends and twists in region 309 such that the surface 310 is generally perpendicular to view from the left of the machine 10. Likewise, the surface 311 is generally perpendicular and exposed to view from areas forward of the machine 10.

The forward-quarter lighting panel 306 is defined by an array of LED emitters. It should be appreciated that the forward-quarter lighting panel 306 can include light sources other than LED emitters such as incandescent bulbs, compact fluorescent bulbs, and the like. The forward-quarter lighting panel 306 includes a refracting lens 312. The refracting lens 312 can be clear or can be one or more colors such as red, amber, or green.

As can be seen in FIG. 13, the right rear-quarter lighting panel 320 is generally rectilinear and extends from an outboard end 322 to inboard end 324. The right rear-quarter lighting panel 320 defines an inboard surface 328 that faces rearward and an outboard surface 326 that faces to the side and to the rear. The right rear-quarter lighting panel 320 includes a bend area 329 which is the transition between the inboard surface 328 and the outboard surface 326. The left rear-quarter lighting panel 320 is configured substantially similarly to the right rear-quarter lighting panel 320.

Continuing to refer to FIG. 13, the outdoor power machine 10 includes a pair of rear outboard light panels 332 that are symmetrically positioned around a rear light panel 336. A ROPS rear light panel 338 is attached to the ROPS 60. The light panels 332, 336, and 338 generally face to the rear of the outdoor power machine 10 and can be seen from a position located generally rearwardly of the outdoor power machine 10.

Referring now to FIG. 12, the outdoor power machine 10 includes a ROPS forward light panel 342 that is attached to the ROPS 60. The outdoor power machine 10 also includes a forward light panel 344. The light panel 344 is positioned on the forward edge of the front axle assembly 26. The light panel 342 and the light panel 344 are visible from positions generally forward of the machine 10.

The ROPS rear light panel 338 and the ROPS forward light panel 342 can be configured, either separately or together, as operational lighting, i.e., headlights and/or floodlights.

FIGS. 5-8 illustrate another exemplary embodiment of an outdoor power machine 110. This embodiment of the machine 110 is a stand-on machine (alternatively referred to as a “stander”). The overall construction of the machine 110 is similar to the machine described above. Elements of the machine 110 not explicitly described may be taken to be identical to the machine 110 described above.

The machine 110 has a chassis 116 including main frame rails 118 extending in a longitudinal direction from a front end 112 of the machine 110 to a rear end 114 of the machine 110. Cross-members 120 interconnect the main frame rails 118. A front axle assembly 126 interconnects the main frame rails 118 at the front end 112 of the machine 110.

The machine 110 is equipped with an electric power pack 128 as described above.

The machine is equipped with left-and right-side drive wheel assemblies 130. Each drive wheel assembly 130 includes an integral drive hub 132 containing an electric motor, a gear reduction drive, and an optional brake (not separately illustrated), a drive wheel 134, and a tire 136 mounted to the drive wheel 134. In the illustrated example, the drive wheel assemblies 130 are located at or near the rear end 114 of the machine 110. Alternatively, the drive wheel assemblies 130 could be located at or near the front end 112 of the machine 110.

The machine 110 is equipped with left-and right-side steer wheel assemblies 138. Each steer wheel assembly 138 includes a pivot assembly 140, a steer wheel 142, and a tire 144 mounted to the steer wheel 142. Each steer wheel assembly 138 is mounted to the chassis 116 such that the steer wheel 142 can rotate relative to the chassis 116 as well as pivot freely about an upright (vertical or near-vertical) axis. The steer wheel assemblies 138 function as casters and therefore passively steer the machine 110. As noted above, the principles described herein are also applicable to a non zero-turn mower (not shown) using a conventional steering linkage to pivot (i.e., actively steer) some or all of the wheels.

The machine 110 is equipped with suitable electrical connections, controls, and switching equipment to permit the operator to control the drive functions of the machine 110. The machine 110 includes a left drive motor controller and a right drive motor controller (Not visible in the figures). Each of these drive motor controllers includes a electrical power connection to the electrical power pack 128 as well as connections to operator controls as described below. Each drive motor controller is operable to receive a command signal from an operator control and to provide electrical power to drive its associated drive wheel assembly 130 at the commanded wheel speed and direction.

The machine 110 includes a body 150 or superstructure positioned above the chassis 116.

The body 150 includes a battery cover assembly 152 which encloses the electric power pack 128. A control pedestal 154 is mounted on top of the battery cover assembly 152.

A foot deck 158 is mounted to the chassis 116 aft of the battery cover assembly 152. This serves as a support for the operator's feet. As illustrated, it may be provided with a raised tread structure to increase traction and avoid slippage. The battery cover assembly 152, the control pedestal 154, and the foot deck 158 collectively define an “operator station” 156 which functions to support the operator to provide access to machine controls during operation.

The body 150 includes left and right fenders 162, 164 respectively which flank the left and right sides of the control pedestal 154. The left fender 162 is topped by a left console 166 and the right fender 164 is topped by a right console 168.

The body 150 carries one or more operator controls within reach of the operator station 156. The primary operator controls include a pair of steering levers 170, one for the left side and one for the right side. Each steering lever 170 is generally L-shaped and includes a vertical section 172 pivotally mounted to the control pedestal 154, and a horizontal section which extends from the top of the vertical section towards the centerline X of the machine 110. Each steering lever 170 is pivotally mounted such that it can move in a fore-aft direction to control drive wheel speed as described above.

Each steering lever 170 is further pivotally mounted so that it can move in a lateral direction between an outboard parking position and a inboard use position. Optionally, the machine 110 may be equipped with parking switches as described above.

Further controls are not separately illustrated but can include one or more of the following: a key switch or other security device; a main power switch; an emergency stop control; a blade start/stop switch; a blade speed control; a drive speed limiter or cruise control; and lighting controls. These further controls may be mounted, for example to the control pedestal 154 or to the left or right consoles 166, 168.

Any of the outdoor power machines described herein may be may be equipped with one or more implements, defined generally as a device attached to or carried by the machine and operable to cut, shape, load, lift, move, or transport material. Nonlimiting examples of implements include mowing decks, plows, disks, scarifiers, rippers, aerators, dethatchers, blades, buckets, scrapers, or blowers.

Referring now to FIGS. 7, 14 and 15; the machine 110 includes a lighting package 400 that is configured to provide 360° illumination generally parallel to the ground plane G, as indicated above. The lighting package 400 includes a pair of forward-quarter lighting panels 406. The lighting panels 406 are substantially similar to the lighting panels 306 and can be understood from the description above.

As can be seen in FIGS. 6 and 15, the machine 110 includes two rear facing light panels 421. The panels 421 are generally rectilinear and are oriented vertically. Each panel 421 is positioned near the side of the rear operator station 156 of the machine 110. Each light panel 421 is configured to emit light such that it can be seen from the direction generally rearward of the machine 110.

Referring now to FIG. 14, the outdoor power machine 110 includes a forward light panel 444. The light panel 444 is positioned on the forward edge of the front axle assembly 126. An array of light panels 454 is positioned along the front edge of the control pedestal 154.

A left forward quarter light panel 458 and a right forward quarter light panel 458 are positioned just outboard of the array of light panels 454. The light panels 406, 444, 454, and 458 are visible from positions generally forward of the machine 110. And, in the case of light panels 458 substantially to the side of the machine 110 as well. The light panels 454 and 458 can be configured as operational lights, i.e., floodlights and/or headlights, in order to better light the work area.

As used herein the term “generally (forward, to the rear, to the side)” indicates that an observer positioned in the indicated direction relative to the outdoor machine 10 or 110 can see the indicated light. The observer does not have to be directly perpendicular to the surface on which the light is mounted such as the front, the rear, or the sides but can be at an angle to such surface. In this regard, lens covers for the lights are configured to distribute light at broad angles relative to the source.

In alternative embodiments, light panels are configured to indicate a status of the machines 10 or 110. In this regard for example, light panels can be configured such that they are green when the machine 10 or 110 is fully charged and a different color such as amber when the machine 10 or 110 requires a charge. Other status indications may be provided not by color, but by a blinking or flashing pattern. A symmetrical off/on pattern can be used wherein each state is the same duration or a more complex pattern can be used to indicate a particular status. In this way multiple statuses can be conveyed by a light panel. Any of the light panels described above can be used to indicate status of the machine 10 or 110.

In the illustrated example, the machine 10 or 110 is equipped with a mowing deck assembly 200 (FIGS. 9, 10). It includes a deck 202 which is an open-bottomed enclosure including a top panel 204 and a peripheral wall 206.

The deck 202 has a nominal designated width which may be selected to provide a desired cutting swath. Non-limiting examples of suitable deck widths include 48 inches, 52 inches, 60 inches, or 72 inches.

One or more mowing blades 208 are rotatably mounted on the underside of the top panel 204. The mowing blades 208 are positioned in a side-by side configuration such that their tips will not collide in operation. The mowing blades 208 may be positioned to have some overlap in at least one dimension so as to prevent un-mowed strips during mower operation. The dimensions of the individual mowing blades 208 are selected to provide adequate structural strength at selected operating speed, (e.g. 3600 RPM). Generally, the size of the individual mowing blades 208 is equal to the deck width divided by the number of mowing blades 208, with some additional diameter provided to accommodate for swath overlap. For example, a deck 202 having a nominal width of 60 inches may use three mowing blades 208 each having a diameter of 20.5 inches.

Means are provided for driving the mowing blades 208. Nonlimiting examples of suitable drive methods include mechanical, hydraulic, or electrical devices. In the illustrated example, each mowing blade 208 is directly driven by its own individual electric blade motor 210.

The mowing deck assembly 200 is connected to the chassis via a deck lift. The deck lift is operable to position the mowing blades 208 at a preselected distance above the ground plane G of the machine. Typical examples include a cutting height in the range of approximately 1 inch to approximately 6 inches. The deck lift is also operable to lift the mowing deck assembly 200 well above any intended cutting height so that the machine can traverse obstacles, travel along a road to a worksite, or be loaded or unloaded from a trailer or storage building. This is referred to as a “travel position”.

In the example shown in FIGS. 1-4, a deck lift 230 includes a foot pedal 232 to raise the deck lift 230. A removable pin 234 is insertable into a selected hole in a blade height adjuster 236. The position of the pin 234 determines a cutting height by blocking the deck lift 230 at a specific position. An uplock lever 238 is provided to selectively lock and release the deck lift 230 in the travel position.

In the example shown in FIGS. 5-7, the mowing deck assembly 200 is connected to the chassis 116 via a deck lift 250. The deck lift 250 is similar to the deck lift 230 described above, the primary difference being that is operated by a hand lever 252 as opposed to a pedal.

The machine described herein has advantages over prior art machines. In this regard, the machine described herein includes a lighting package configured such that the machine is visible 360° around it. In this way, the operation of the machine can be more safe in that people can see the machine and avoid it as necessary. Furthermore, the lighting package can include operational lights i.e. floodlights and/or headlights to allow for the operator to better see the environment which the machine is operating.

The foregoing has described an outdoor power machine. All of the features disclosed in this specification, and/or all of the steps of any method or process so disclosed, may be combined in any combination, except combinations where at least some of such features and/or steps are mutually exclusive.

Each feature disclosed in this specification may be replaced by alternative features serving the same, equivalent or similar purpose, unless expressly stated otherwise. Thus, unless expressly stated otherwise, each feature disclosed is one example only of a generic series of equivalent or similar features.

The invention is not restricted to the details of the foregoing embodiment(s). The invention extends, or to any novel one, or any novel combination, of the steps of any method or process so disclosed.

What is claimed is:

1. An outdoor power machine, comprising:
a chassis including main frame rails;
two or more drive wheel assemblies physically mounted to the chassis, each drive wheel assembly coupled to an electric motor;
an electrical power pack configured to supply electric energy to the electric motors;
one or more steer wheels; and
a lighting package mounted on the machine such that the lighting package is visible from at least one of: the forward and rear aspects of the machine, and at least one of: the left and right aspects of the machine.

2. The outdoor power machine of claim 1, wherein the lighting package includes at least one forward quarter lighting panel.

3. The outdoor power machine of claim 2, wherein the forward quarter lighting panel defines two light-emitting surfaces.

4. The outdoor power machine of claim 3, wherein the two light-emitting surfaces intersect at a region where the lighting panel bends and twists such that a first surface is generally perpendicular to view from the left or right aspect of the machine and a second surface is generally perpendicular and exposed to view from areas forward of the machine.

5. The outdoor power machine of claim 1, wherein the lighting package includes at least one rear quarter lighting panel.

6. The outdoor power machine of claim 5, wherein the rear quarter lighting panel defines two light-emitting surfaces.

7. The outdoor power machine of claim 6, wherein the two light-emitting surfaces intersect at a region where the lighting panel bends such that a first surface is generally perpendicular to view from the left or right aspect of the machine and a second surface is generally perpendicular and exposed to view from areas rear of the machine.

8. The outdoor power machine of claim 1, wherein the lighting package includes at least one forward quarter lighting panel and at least one rear quarter lighting panel.

9. The outdoor power machine of claim 8, wherein each of the forward and rear quarter lighting panels define two light-emitting surfaces.

10. The outdoor power machine of claim 9, wherein the two light-emitting surfaces intersect at a region where the lighting panel is configured such that a first surface is generally perpendicular to view from the left or right aspects of the machine and a second surface is generally perpendicular and exposed to view from areas rear of the machine.

11. The outdoor power machine of claim 1, wherein the lighting package is configured to indicate the status of the machine.

12. The outdoor power machine of claim 11, wherein the status is indicated by blinking lights.

13. The outdoor power machine of claim 11, wherein the status is indicated by a predetermined color of light.

14. The outdoor power machine of claim 11, wherein the machine includes batteries and the status is indicative of whether the electrical power pack is charged.
